(19) United States
(12) Patent Application Publication
(10) Pub. No.: US 2025/0184306 A1
(43) Pub. Date: Jun. 5, 2025

(54) METHOD FOR CHANGING THE MAC ADDRESS OF A NON-AP STATION FOR A NEXT ASSOCIATION WITH AN AP STATION

(71) Applicant: CANON KABUSHIKI KAISHA, Tokyo (JP)

(72) Inventors: Julien SEVIN, SAINT AUBIN DU CORMIER (FR); Stéphane BARON, LE RHEU (FR); Patrice NEZOU, LIFFRE (FR)

(21) Appl. No.: 18/840,730

(22) PCT Filed: Feb. 16, 2023
(86) PCT No.: PCT/EP2023/053966

§ 371 Date: Aug. 22, 2024

(30) Foreign Application Priority Data
Feb. 24, 2022 (GB) 2202549.8

(51) Int. Cl. H04L 61/5038; H04L 61/5092; H04L 101/622; H04W 84/12

(52) U.S. Cl. CPC H04L 61/5038; H04L 61/5092; H04L 2101/622; H04W 84/12

(57) ABSTRACT

The invention proposes to generate a new MAC address for a non-AP station while being associated with an AP station, for use when associating again with the same AP station. For privacy reason, the same new MAC address is generated locally at both the non-AP station and the AP station using a shared function. This is done in a synchronized manned, preferably at the end of the association, e.g. when disassociating. The non-AP station disassociates with the AP station, and at any time in the future, it may associate again with the same AP station using this new MAC address. The AP station is therefore able to recognize the non-AP station, while outside observers only see a new MAC address and thus see a new non-AP station associating with the AP station. User privacy is therefore reinforced over time as the non-AP station associates multiple times to the same AP.

### FIELD OF THE INVENTION

The present invention relates to wireless communications and more specifically to user privacy during wireless communications.

### BACKGROUND OF INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a great number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

In particular, the Media Access Control (MAC) address, or EUI-48 address, of a user device is an Extended Unique Identifier (EUI) composed of 48 bits and constitutes a piece of data that can be used to track this user. Indeed, the access points (APs) of wireless networks can monitor the locations of mobile devices (tablets, laptops, mobile phones, . . . ) of a user without his consent, by means of their MAC addresses. This is because mobile phones are configured to discover surrounding access points to wireless networks. As the user moves, his mobile phone sends requests to determine if there are any access points nearby, these requests identifying the mobile phone which sends it and including in particular the MAC address of the mobile phone. Access points that hear this request can respond. In the context of Wi-Fi networks as defined by IEEE 802.11 standards, this procedure is called Probe Request/Response exchange.

So even when the phone is not connected to a Wi-Fi network, surrounding access points receive its MAC address. It is then possible to track a user by reconstructing his trajectory from access points to which his phone has sent his MAC address. Also, if the phone has been associated with one of the access points (i.e. the user has connected to an associated Wi-Fi network through that access point) and the user has indicated personal identification information (name, place of residence, . . . ) in the past, the access point may have recorded in a database the MAC address of the phone in association with the identification information. Therefore, even if the user is not connected to the Wi-Fi network, this identity information could be recovered by comparing the MAC address contained in a Probe Request to the MAC address used for the past association.

In the context of Wi-Fi networks, a solution has been proposed by the IEEE 802.11 working group to limit the risk of a user being traced, and consists in dynamically modifying the MAC address of the user device. This mechanism is called Randomized and Changing MAC (RCM) procedure. It has been originally introduced as a privacy enhancing feature in the 802.11aq Pre-Association Service Discovery Task Group and finally included in the standard IEEE Std 802.11-2020. It comprises periodical change of the MAC address of a non-AP STA (i.e. a station which is not an access point) to a random value, while the non-AP STA is not associated to a network (or, equivalently, to an access point). The non-AP STA may construct the randomized MAC address from the locally administered address space as defined in IEEE Std 802®—2014 and IEEE Std 802c™—2017. The random generator algorithm used for generating the MAC address is implementation dependent and is not standardized.

New IEEE P802.11bh task group considers the merits and challenges presented by randomized and changing MAC addresses within an 802.11-based network.

A key issue with the RCM procedure is that the AP must be able to recognize the associated RCM STA as it rotates its MAC.

However, while RCM increases user privacy, it also leads to potential connectivity issues and possible disruption of the user experience. An example is when users wish to make use of a public Wi-Fi network in a coffee shop, hotel, doctor's office, or elsewhere. Because many captive portals use static MAC addresses as identifiers, the user may need to log-in repeatedly and re-submit information as their MAC address changes. In other cases, the user may need to authenticate and log-in again when the device idles, disconnects, and reconnects via a different MAC address. Another example is when families set parental controls on children's devices for screen time and content. These limits are often enforced by a device's MAC address, and if the address changes, the controls may prevent access to allowed content, or no longer apply.

IEEE P802.11 bh thus seek to design mechanisms to optimize the user experience when a device uses a RCM procedure allowing a device to be identifiable when it reassociates with an AP previously associated. However, conventional mechanisms to do so are not efficient and require high processing or/and high memory/storage requirements or/and setup complexity.

### SUMMARY OF THE INVENTION

It is a broad objective of the present invention to overcome some of the foregoing concerns. In order to avoid these drawbacks, the invention proposes to anticipate the next MAC address to be used for reassociation with the same AP station, by no longer using the current RCM procedure but a pseudo random generator algorithm shared with the AP station. Randomization of the MAC address is kept to ensure the same level of user privacy while the shared next MAC address, although it changes, allows the non-AP station to be identifiable/recognizable by the AP station.

In particular, the invention provides a method for changing a value of an Extended Unique Identifier, EUI, of a non-access point, non-AP, station, the method comprising at the non-AP station:
while being associated with an AP station, generating a new value of the EUI of the non-AP station by using an EUI-generating function shared with the AP station; and
using the new value of the EUI when next associating with the AP station.

Conversely, the invention also provides a method for changing a value of an Extended Unique Identifier, EUI, of a non-access point, non-AP, station, the method comprising at an AP station:
generating a new value of the EUI of a non-AP station currently associated with the AP station, by using an EUI-generating function shared with the non-AP station;
using the new value of the EUI when next associating the non-AP station.

Thanks to the shared function, the new EUI value is also shared between the non-AP station and the AP station. It turns out that, upon next association of the non-AP station using that shared new value, the AP station directly recognizes the non-AP station, even if it has rotated its EUI (MAC address). User privacy is kept as, from the outside, a new and unknown MAC address is used.

Optional features of these embodiments of the invention are defined in the appended claims. Some of these features are explained here below with reference to a method, while they can be transposed into device features.

In some embodiments, the method at the non-AP station further comprises: determining whether the non-AP station locally stores an EUI value in association with the AP station (e.g. through a corresponding BSSID), and in the affirmative, using the stored EUI value to associate with the AP station, otherwise using a default EUI value to associate with the AP station.

A default EUI value is to be understood as not being generated through the shared function, i.e. it is not an EUI value yet known by the AP station. For example, the default EUI value is a random MAC address obtained through Randomized and Changing procedure (e.g. as defined in 802.11aq Pre-Association Service Discovery Task Group amendment to the 802.11-2016). In a variant, it may be a (static) physical burned-in MAC address.

Conversely, the method at the AP station may further comprise: receiving, from a non-AP station, a management request (e.g. probe or association request) signaling a value of an EUI of the non-AP station; searching for the signaled EUI value within EUI values locally stored at the AP station and obtaining a unique local identifier associated with the locally-stored EUI value matching the signaled EUI value. The unique local identifier is used locally by the AP station to identify the requesting non-AP station. This embodiments allows the AP station to recover such unique identifier from the EUI value signaled by the non-AP station in its management request to the AP station.

In some embodiments where such unique local identifier can be found, the method at the AP station may further comprise updating a current value of the EUI of the non-AP station locally associated with the unique local identifier, with the generated new value of the EUI. In that way, the AP station keeps track of each and every new EUI values the non-AP station can use for their next association with the same AP station.

In some embodiments where such unique local identifier cannot be found, the method at the AP station further comprises locally associating the generated new value of the EUI with a unique local identifier. In that way, a new local identifier is allocated to the non-AP station, for example when first associating with the AP station or when it reassociates but does not want to be recognized by the AP station.

In some embodiments where the non-AP station wishes to end with the shared approach, the method at the non-AP station may comprise: performing a further next association with the AP station using a value of the EUI of the non-AP station different from a value of the EUI generated using the EUI-generating function shared with the AP station.

Indeed, the non-AP station may stop using the successively generated shared EUI values (allowing the AP station to know which station associates each time) to use a new EUI value unknown from the AP station, so as to keep full privacy from AP perspective.

In some embodiments, the method at the non-AP station comprises disassociating from the AP station before using the new value of the EUI to next associate with the AP station. Conversely, the method at the AP station may further comprise disassociating the non-AP station before receiving, from the non-AP station, a request to associate again using the new value of the EUI.

In some embodiments, disassociating is made based on a current value of the EUI of the non-AP station different from the new value of the EUI.

In some embodiments, generating the new value of the EUI for the next association is performed during disassociation between the non-AP station and the AP station.

In some embodiments, the method at the non-AP station comprises: receiving a beacon frame from an AP station; searching, in a local registry, for an EUI value associated with a BSSID (Basic Service Set Identifier) of the AP station; and sending a management request to the AP station using a found EUI value associated with the BSSID (e.g. as the Transmit Address); otherwise using a default EUI value.

In that way, the non-AP station can join a BSS upon detecting a corresponding beacon frame, by using the EUI value shared with the AP station.

In other embodiments, the method at the non-AP station comprises: while not being associated with an AP station; sending one or more management requests (e.g. probe requests) to one or more respective AP stations; receiving a management response from one of the respective AP stations, searching, in a local registry, for an EUI value associated with a BSSID of the responding AP station; and sending a further management request to associate with the responding AP station, wherein the further management request includes a found EUI value associated with the BSSID; otherwise includes a default EUI value. Again, the non-AP station can actively associate with a BSS by using the EUI value shared with the corresponding AP station when the former has already registered (associated) to the latte.

In some embodiments of the invention, the method (at either the AP station or non-AP station or both) may further comprise: while the non-AP station is associated with the AP station, generating a plurality of successive new values of the EUI for the non-AP station by using the shared EUI-generating function; wherein a last generated new value of the EUI is used when performing the next association. The multiple new EUI values (except the last one) may for instance be used to changing the EUI (MAC address) of the non-AP station over time during operations within the BSS with which it is continuously associated. The last EUI value is kept for the next association with the same BSS, once disassociated.

In particular, the last generated new value may be generated when performing disassociation of the non-AP station from the AP station.

In some embodiments of the invention, generating the new value of the EUI includes calculating the new value of the EUI by using a shared secret (e.g. a key) and a current value of a shared parameter as inputs of the shared EUI-generating function. As an example, the shared parameter may be a current value of the EUI of the non-AP station (e.g. the current value when disassociating).

Correlatively, the invention also provides a wireless communication device comprising at least one microprocessor configured for carrying out the steps of any of the above methods. The wireless communication device is thus either a non-AP station or an AP station.

In particular, the non-AP station may comprise a local registry which associates one or more BSSIDs (i.e. AP stations) with one or more EUI values respectively. This local registry allows the non-AP station to store the EUI value to be used with each of the AP stations in order to be quickly recognize by them, despite the change of EUI value (MAC address).

On the other hand, the AP station may comprise a local registry which associates one or more unique local identifiers for stations with one or more EUI values respectively. Similarly, this local registry allows the AP station to quickly recognize a non-AP station based on a received EUI value, despite the change of EUI value of the non-AP station since the last association.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which embodiments of the invention may be used;

FIG. 1a illustrates an exemplary association sequence of management frames allowing a not-yet-associated non-AP station to discover and register with an AP in order to join the corresponding BSS;

FIG. 1b illustrates an example of a frame format to advertise the capability of a station to support the PRCM mechanism, according to one or several embodiments of the invention;

FIG. 2 illustrates, using a flowchart, exemplary steps of a non-AP station performing a discovery phase when associating with an AP, either through passive scanning or active scanning;

FIG. 3 illustrates, using a flowchart, general steps at a non-AP station to manage, in particular to activate, the PRCM mechanism according to embodiments of the invention;

FIG. 4 illustrates, using a flowchart, general steps at the AP to manage, in particular to activate, the PRCM mechanism according to embodiments of the invention;

FIG. 5 illustrates, using a flowchart, exemplary steps at an associated non-AP station or at the AP during communication operations between them within the BSS;

FIG. 6 illustrates an exemplary sequence of messages between the AP and the non-AP station to exchange a PRCM key used by the shared PRCM mechanism according to embodiments of the invention;

FIG. 7 illustrates examples frame formats to initiate the PRCM mechanism by exchanging the PRCM Key, according to one or several embodiments of the invention,

FIG. 8 illustrates an example of a communication device of a wireless network, configured to implement at least one embodiment of the present invention.

### DETAILED DESCRIPTION OF THE INVENTION

According to embodiments, the invention proposes to generate a new MAC address for a non-AP station while being associated with an AP station, for use when associating again with the same AP station. For privacy reason, the same new MAC address is generated locally at both the non-AP station and the AP station using a shared function. This is done in a synchronized manned, preferably at the end of the association, e.g. when disassociating. The non-AP station disassociates with the AP station, and at any time in the future, it may associate again with the same AP station using this new MAC address. The AP station is therefore able to recognize the non-AP station, while outside observers only see a new MAC address and thus see a new non-AP station associating with the AP station. User privacy is therefore reinforced over time as the non-AP station associates multiple times with the same AP.

The non-AP station proceeds in the same way with other AP stations with which it associates over time. Similarly, various non-AP stations proceed in the same way when associating with the same AP station.

In one or more embodiments, the invention therefore relates to a method for changing a value of an Extended Unique Identifier, EUI, e.g. a MAC address, of a non-access point, non-AP, station. The non-AP station, while being associated with an AP station, generates a new value of the EUI of the non-AP station by using an EUI-generating function shared with the AP station. The non-AP station then uses the new value of the EUI when next associating with the AP station.

Similarly, the AP station generates a new value of the EUI of a non-AP station currently associated with the AP station, by using an EUI-generating function shared with the non-AP station. The AP station then uses the new value of the EUI when next associating the non-AP station.

In the following, the procedure for changing the MAC address of a non-AP station already associated with an AP station with a view of using it for the next association of the non-AP station with the same AP station is referred to as “Pseudo RCM Procedure”, or PRCM procedure. The corresponding mechanism or algorithm is referred to as PRCM mechanism.

Even if the following description is focused on the change of MAC address, the invention can be applied for other types of identifiers, for instance other Extended Unique Identifiers (EUIs), such as EUI-64.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP or AP station) or not (so-called non-AP STA or non-AP station).

While the examples and embodiment are described in the context of Wi-Fi networks, the invention may be used in any type of wireless networks, like, for example, mobile phone cellular networks that implement very similar mechanisms.

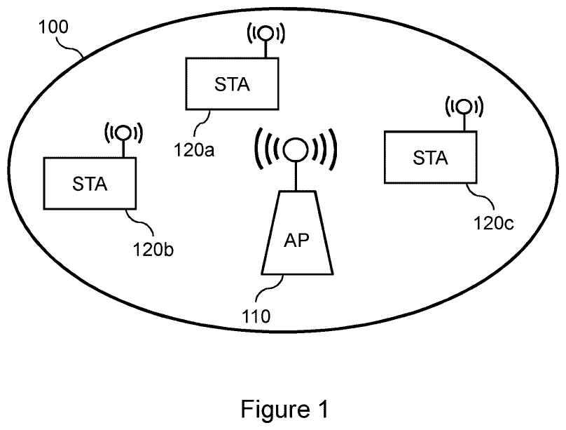

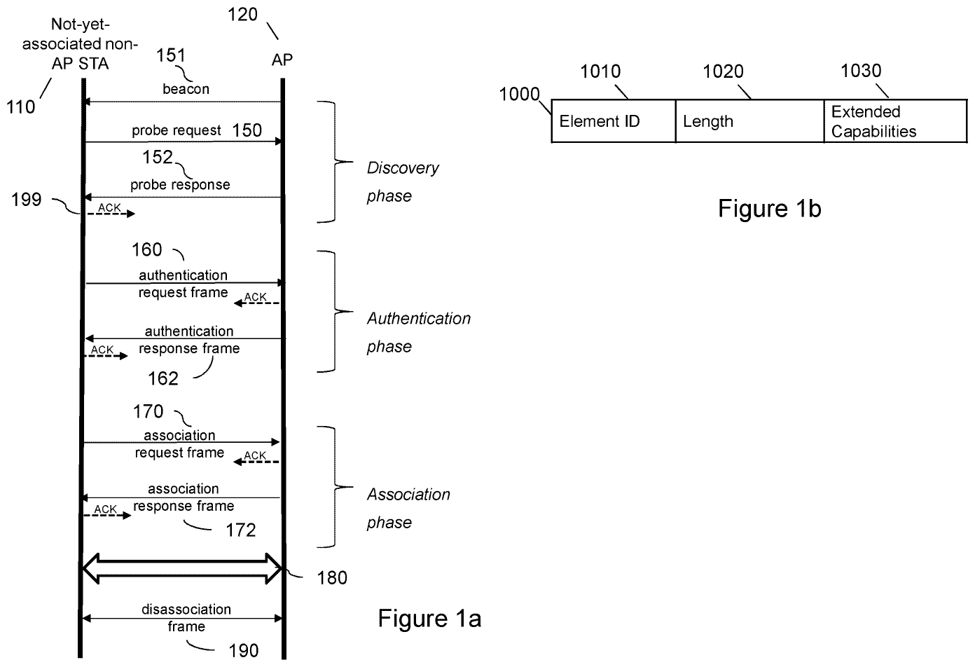

FIG. 1 illustrates an example of a network system in which embodiments of the invention may be used.

FIG. 1 represents an 802.11 network (i.e. a Wi-Fi network) system 100 comprising four wireless devices: an access point (AP) 110 and three non-AP STAs (non-AP STAs) 120a, 120b, 120c. Of course, the number of non-AP STAs 120a, 120b, 120c may be different from three. The AP 110 provides wireless connections between the non-AP STAs 120a, 120b, 120c and a wider network, such as the Internet. The connection of a non-AP STA 120a, 120b, 120c to the AP 110 is performed by a standardized process called association. Once a non-AP STA 120a, 120b, 120c is associated with the AP 110, the non-AP STA 120a, 120b, 120c can send data to the network and receive data from the network through the AP 110.

The AP 110 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance a broadband remote access server (BRAS).

A non-AP STA 120a, 120b, 120c may comprise, be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, a non-AP STA 120a, 120b, 120c may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA 120a, 120b, 120c may be a wireless node. Such wireless node may provide, for example, connectivity for or to a network (e.g., a wide area network such as the Internet or a cellular network) via a wired or wireless communication link.

The AP 110 manages a set of stations that together organize their accesses to the wireless medium for communication purposes. All the stations (AP 110 and non-AP STA 120a, 120b, 120c) form a service set, which may be referred to as basic service set, BSS (although other terminology can be used). It is noted that the AP 110 may manage more than one BSS: each BSS is thus uniquely identified by a specific basic service set identifier (BSSID) and managed by a separate virtual AP implemented in the physical AP 110.

In order to ensure the user privacy, the non-AP STA 120a, 120b, 120c have been configured with a dot11 MACPrivacyActivated set to true. This is a Management Information Base (MIB) variable controllable by an external management entity to define whetherthe non-AP station can apply (variable set to true) specific mechanisms for enhancing the privacy at MAC level, including the RCM procedure, or not (variable set to false).

FIG. 1a illustrates an exemplary sequence of association management frames allowing a not-yet-associated non-AP STA 120 to discover and register with the AP 110 in order to join the corresponding BSS.

It comprises three phases: WLAN or BSS discovery, authentication and association, at the end of which the station enters into an authenticated and associated state with the AP. Note that the non-AP station may be currently associated with a first AP (i.e. belonging to a first WLAN) and willing to join a second WLAN (with which it is not associated). The WLAN discovery phase may be performed simultaneously by the non-AP STA with multiple APs, for instance to choose the best BSS.

The WLAN discovery can be done through passive and/or active scanning operations on frequency channels in one or more of the frequency bands (typically 2.4 GHz, 5 GHz and 6 GHz bands). This is for the unassociated non-AP STA to gather network information about the APs.

The passive scanning consists for the unassociated non-AP STA in listening beacon frames 151 sent periodically by an AP on the medium. The beacon frames 151 provide details on the BSS: SSID (wireless network name), supported data rates, encryption types, and other 802.11 capabilities of the AP.

The active scanning consists in an exchange of management frames between the unassociated non-AP STA and the AP, for instance by sending out Probe Request frames 150 on the wireless channel. For example, the non-AP STA may send such a management frame to each AP it knows (e.g. to each AP with which it has already been associated in the past). In response to receiving such a Probe Request frame, the AP checks whether the unassociated non-AP STA has a common supported data rate or not. In the affirmative, the AP responds with a Probe Response frame 152 providing details on the BSS: SSID (wireless network name), supported data rates, encryption types, and other 802.11 capabilities of the AP.

A non-AP STA (possible already registered for a WLAN but seen as unassociated for other WLANs) may send Probe Request frames regularly onto otherwireless channels to maintain an updated list of available WLANs without any intend to associate with the other WLANs. However, it allows the non-AP STA to possible roam to another AP with a better signal strength (using the second and third phases of the association procedure) if needed.

In particular, the Beacon frames 151 and/or the Probe Response frames 152 may include a declaration from the AP of a support of the PRCM procedure according to the invention. Also, the Probe Request frame 150 may include a declaration from the non-AP STA of a support of the PRCM procedure according to the invention.

Once the unassociated non-AP STA has decided to join a WLAN (based on network information gathered from the various WLANs), it performs the second and authentication phase during which it sends a low-level 802.11 Authentication Request frame 160 to the selected AP. The AP may respond with an Authentication Response frame 162.

Again, the unassociated non-AP STA may authenticate to multiple APs without seeking to be associated with them. This is to speed up the whole association procedure when the unassociated non-AP station finally decides to move to another WLAN.

Next, the unassociated non-AP STA performs actual association with the AP to join the WLAN cell (or BSS). This stage finalizes the security and bit rate options and establishes the data link between the unassociated non-AP STA and the AP. The purpose of this final exchange is for the unassociated non-AP station to obtain its Association Identifier (AID) to be used to access the medium and send data within the joined BSS. To do so, the unassociated non-AP STA sends an Association Request frame 170 to the AP of the BSS it wishes to join. The Association Request frame contains chosen encryption types if required and other compatible 802.11 capabilities.

In particular, the Association Request frame 170 may include a declaration from the non-AP STA of a support of the PRCM procedure according to the invention.

FIG. 1b illustrates an example of a frame format to advertise the capability of a station (AP or non-AP STA) to support the PRCM procedure, according to one or several embodiments of the invention. A PRCM Capability field is used in the non-AP STA and AP to advertise their capability to support the PRCM mechanism.

In one or more embodiments, the capability for the station to support PRCM procedure may be signaled during association using an Extended Capabilities Information Element (IE) 1000 contained in the exchanged management frames as defined in the section 9.4.2.26 of the standard IEEE Std 802.11-2020.

As represented in FIG. 1b, the Extended Capabilities IE 1000 contains three fields: an Element ID field 1010, a length field 1020 and an Extended Capabilities field 1030. The Element ID field 1010 is set to value ‘127’ corresponding to ‘Extended Capabilities’ extended. The length field 1020 indicates the number of octets in the Extended Capabilities field 1030 excluding the Element ID field 1010 and the length field 1020. For illustrative purpose, it may be set to n=16 octets. The Extended Capabilities field 1030 is a bit field indicating the extended capabilities being advertised by the station transmitting the IE. The Extended Capabilities field is shown in Table 9-153 of the standard IEEE Std 802.11-2020.

A bit so far reserved in the standard may be assigned to the PRCM capability, to indicate whether the station supports PRCM procedure or not. It may correspond to the k-th bit of the Extended Capabilities field 1030, k being an integer between 88 and 8*n, n being the length of the Extended Capabilities field 1030 expressed in number of bytes. When this bit is set to 1, it indicates that the station supports the PRCM procedure, and when this bit is set to 0, it indicates that the PRCM procedure is not supported by the station.

A new row may be added to Table 9-153—Extended Capabilities field, Clause 9.4.2.26 of the standard IEEE Std 802.11-2020, as follows.

| Bit | Information | Notes |
|---|---|---|
| k | Pseudo RCM | The STA sets Pseudo RCM Capabilities |
| | Capability | bit to 1 to indicate support for PRCM and sets to 0 if |
| | | PRCM is not supported. |

Back to FIG. 1a, if the elements in the Association Request frame match the capabilities of the AP, the AP creates an Association ID (AID) for the unassociated non-AP STA and responds with an Association Response frame 172 including the AID and a success message granting network access to the non-AP STA. Now the non-AP STA is successfully associated with (registered to) the AP and data transfer (180) can begin in the chosen BSS using the AID.

At any time, the non-AP STA may disassociate from the BSS, on its own initiative or on AP's initiative, through the exchange of a Disassociation frame 190.

The Beacon frame 151, Probe Response frame 152, Authentication Request/Response frames 160 and 162, Association Request/Response frames 170 and 172 and Disassociation frame 190 are management frames emitted in an 802.11 legacy format, known as a single user (SU) format. Each of these management frames is acknowledged by an ACK frame 199.

As mentioned above, embodiments of the present invention provides a method for a non-AP STA to change its MAC address when it intends to associate again with an AP, while remaining identifiable by the AP if the non-AP STA has been previously associated with it. The change of MAC address is performed during the previous association with the AP, in such a way both the AP and the non-AP STA already knows the next MAC address that will be used (for the next association) when disassociating from the previous association. To that end, the same MAC address generating function is used, e.g. based on the known RCM procedure. The method is thus referred to as Pseudo RCM (PRCM) procedure/mechanism, and the MAC address generated by this procedure are named below PRCM address.

The main function of the PRCM mechanism is to generate and assign the next MAC address (PRCM address) to be used by the non-AP STA to initiate the next association procedure with a given AP. A non-AP STA may manage several PRCM addresses, each one corresponding to a given AP for its next association with that AP.

If the AP is not PRCM-capable or before generating the first PRCM address with the AP, the non-AP STA may use a default MAC address for initiating the association procedure with the AP. For example, the default MAC address may be one from:
the conventional static MAC address of the non-AP STA (physical burned-in MAC address),
a random MAC address obtained through Randomized and Changing procedure (RCM procedure as defined in 802.11 aq Pre-Association Service Discovery Task Group amendment to the 802.11-2016),
a default value.

The default MAC address is thus used when the PRCM mechanism is not yet active at the AP and non-AP STA. In such a case, the non-AP STA is considered as PRCM-inactive for the AP and the AP as PRCM-inactive for the non-AP STA.

However, once the non-AP STA and AP use the PRCM mechanism to generate a PRCM address for the next association between the same two stations, the PRCM mechanism can be used again to generate the series of next MAC addresses for the subsequent successive associations between the two stations. In such a case, the non-AP STA is considered as PRCM-active for the AP and the AP as PRCM-active for the non-AP STA.

The PRCM mechanism with a given AP can be stopped at any time on the non-AP STA's initiative by merely performing the next association with the AP using a MAC address different from the current PRCM address (shared by both stations) generated using the PRCM mechanism. In such a case, the non-AP STA is considered back as PRCM-inactive for the AP and the AP as PRCM-inactive for the non-AP STA. Of course, the new association with the different MAC address may start a new series of PRCM addresses where both stations are PRCM-active for the other station.

With a series of PRCM addresses, the AP is able to follow or track the non-AP STA (i.e. recognize the same non-AP STA) over its multiple successive associations with the non-AP STA over time. By stopping the PRCM mechanism, the non-AP STA breaks the above capability of the AP to track it. Therefore, user privacy of fully controlled by the non-AP STA.

Note that the AP is not aware that the non-AP STA will never use a PRCM address again. Hence, from the AP perspective, the non-AP STA corresponding to this PRCM address is still seen as PRCM active, although it will never associate again. The PRCM addresses may be reset at the AP when the latter reboots, in order to clean old unused PRCM addresses.

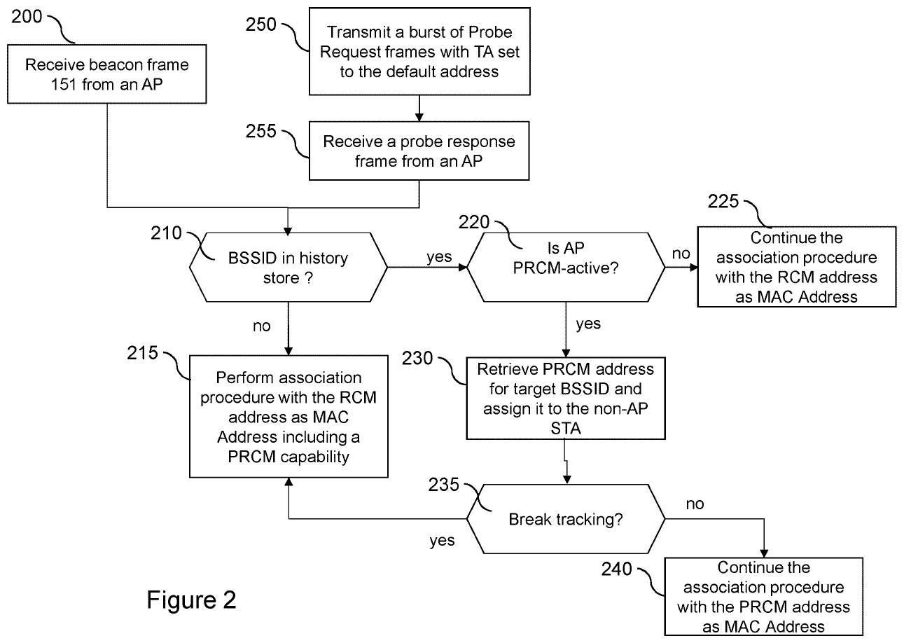

FIG. 2 illustrates, using a flowchart, exemplary steps of a non-AP STA performing a discovery phase when associating with an AP, either through passive scanning or active scanning. The non-AP STA may yet have or not associated with some or all the APs in its surrounding, hence it may yet have or not a PRCM address for one or more of the APs.

The passive scanning includes for the non-AP STA to receive a beacon frame 151 from a target AP (step 200). The beacon frame 151 may signal the target AP supports the PRCM mechanism or not.

At step 210, the non-AP STA determines whether it has already been associated with the target AP. This can be made by merely retrieving the BSSID or/and SSID (of the target AP) contained in the beacon frame 151 and searching for it (the BSSID or/and SSID) in a history store local to the non-AP STA, referred to below as local registry.

Such history store or local registry may store all the BSSID or/and SSID and corresponding network information that have been encountered or even to which the non-AP STA has already registered (associated). In embodiments of the invention, the local registry may furthermore store the PRCM address (addresses) in association with the AP (APs) for which it has been generated, as explained below.

If the BSSID of the target AP (as signalled in the beacon frame) is not found in the local registry, it means there is no PRCM address already generated for the target AP. The non-AP STA hence only has its default MAC address, e.g. an RCM address. In that case, next step is step 215 where the non-AP STA performs the association procedure using its default MAC address, e.g. its RCM address as MAC address as it is specified in the standard IEEE Std 802.11-2020.

In particular, the non-AP STA sends a Probe Request frame 150 with a transmitter address (address 2) set to its default/RCM address. The Probe Request frame 150 preferably contains Extended Capabilities Information Element (IE) 1000 as described above with reference to FIG. 1b in order to indicate it supports the PRCM mechanism or not. The other steps for the association are those described with reference to FIG. 1a.

If the BSSID or SSID of the target AP (as signalled in the beacon frame) is found in the local registry, meaning for example the non-AP STA has already been associated with that AP, the non-AP STA checks whether the target AP is PRCM-active with the non-AP STA, by checking in the history store (local registry) whether a PRCM address (referred to as @MAC(m)) corresponding to the target AP has already been generated. This is step 220.

In the negative, the PRCM mechanism is not active with the target AP. Therefore, the non-AP STA needs to use the default MAC address, typically the RCM address. Hence, at step 225, the non-AP STA performs the association procedure using its default MAC address, e.g. its RCM address as MAC address as it is specified in the standard IEEE Std 802.11-2020. In particular, the non-AP STA sends a Probe Request frame 150 with a transmitter address (address 2) set to its default/RCM address. There is no need that the Probe Request frame 150 contains an Extended Capabilities Information Element (IE) 1000 to indicate a support of the PRCM mechanism.

In the affirmative of test 220, the non-AP STA has already been associated with the PRCM-capable target AP. This means a PRCM address has already been generated (during the last association as explained below), which is stored in the local registry in association with the target BSSID or SSID.

At step 230, the non-AP STA thus retrieves the PRCM address @MAC(m) of the non-AP STA, corresponding to the target AP (identified by “m” in the notation of the PRCM address) and assigns it to itself for its communication with the target AP only (because each AP has its own independent PRCM address with the same non-AP STA).

As mentioned above, the PRCM address may be used by the non-AP STA for the next association with the same AP. However, should the non-AP STA wish to break its current tracking by the AP, it may come back to the default MAC address.

Therefore, following step 230, the non-AP STA determines whether it wants to break its tracking by the AP to restore confidentially and user privacy.

In the affirmative, the non-AP STA goes to step 215 where it performs the association procedure using its default MAC address, e.g. its RCM address. As mentioned above, it sends a Probe Request frame 150 with the transmitter address (address 2) set to its default/RCM address, and with the Extended Capabilities Information Element (IE) 1000 set to indicate it supports the PRCM mechanism.

In the negative of step 235, the non-AP STA performs the association procedure using the stored PRCM address @MAC(m) known by itself and the target AP. This is step 240. For example, the non-AP STA transmits a Probe Request frame 150 with the transmitter address (address 2) set to the PRCM address @MAC(m). The Probe Request frame 150 preferably contains an Extended Capabilities Information Element (IE) 1000 as described above with reference to FIG. 1b in order to indicate it supports the PRCM mechanism or not. The other steps for the association (Probe Response frame, Authentication frames, Association frames) are those described with reference to FIG. 1a.

As exemplified above, in the passive scanning approach, the non-AP station receives a beacon frame from an AP station; searches, in a local registry, for an EUI value associated with a BSSID (Basic Service Set Identifier) of the target AP station; and sends a management request (Probe Request frame for example) to the AP station using a found EUI value associated with the BSSID (e.g. as the Transmit Address); otherwise using a default EUI value.

Turning now to the active scanning, it is recalled that the local registry of the non-AP STA lists the history of past associations with AP, hence lists one or more BSSIDs to which the non-AP STA has already registered. Of course, this list may be supplemented by adding manually other APs. Therefore a list of one or more BSSIDs is available in the local registry. One or more of these BSSIDs may also be associated with one or more respective PRCM addresses that were generated during the last association with the corresponding AP (in case the PRCM mechanism is enabled at both the non-AP STA and the AP).

At step 250, the non-AP STA willing to perform an active scanning transmits a burst of Probe Request frames 150 as it is specified in the standard IEEE Std 802.11-2020, for all the BSSIDs (or APs) in the above list. Each Probe Request frame 150 has a transmitter address (address 2) set to the same non-AP STA's address, typically the above default MAC address such as the RCM address, and has a destination address (address 1) set to a target BSSID. The Probe Request frames 150 of the burst thus are different in that they have different destination addresses corresponding to the various BSSIDs of the list (of previously associated APs).

Moreover, each Probe Request frame 150 may contain an Extended Capabilities Information Element (IE) 1000 as described above in order to indicate the non-AP STA supports the PRCM mechanism or not.

The non-AP STA next waits for one or more responses from the destination APs. If several ones are received, the non-AP STA may select one of them, corresponding to a target AP.

Hence, at step 255, the non-AP STA receives a Probe Response frame 152 from the target AP. The Probe Response frame 152 may signal the target AP supports the PRCM mechanism or not.

The process goes on at step 210 described above in order to perform an association using the PRCM address @MAC(m) for the target AP if such address exists in the local registry of the non-AP STA (steps 230, 235, 240) or to perform a conventional association using the default address in case the PRCM mechanism is inactive or cannot be activated.

Therefore, as exemplified above, in the active scanning approach, the non-AP station, while not being associated with an AP station, sends one or more management requests (e.g. probe requests) to one or more respective AP stations, receives a management response from one of the respective AP stations, searches, in a local registry, for an EUI value associated with a BSSID of the responding AP station and sends a further management request to associate with the responding AP station. The further management request includes a found EUI value associated with the BSSID; otherwise it includes a default EUI value.

Once the non-AP STA is associated with the target AP, transmission operations 180 (FIG. 1a) are performed.

The PRCM mechanism may already been activated between the non-AP STA and the target AP, in particular when it was activated during a previous association.

Upon first association with the target AP or when the non-AP STA intentionally uses the default address to associate in order to break the station tracking by the target AP, the PRCM mechanism between the two stations can be activated. Otherwise, the PRCM mechanism can already be active when associating again with the same target AP.

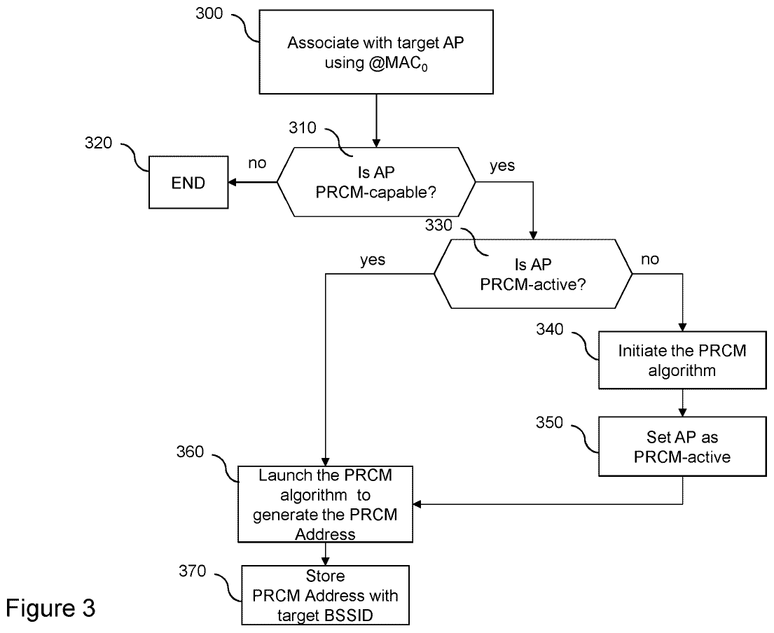

FIG. 3 illustrates, using a flowchart, general steps at a non-AP STA to manage, in particular to activate, the PRCM mechanism according to embodiments of the invention.

As mentioned above, when the non-AP STA performs an association with a target AP, its current MAC address @MAC₀ is either the default address (RCM address issued from a RCM procedure) or the PRCM address @MAC(m) issued from the PRCM mechanism if the latter was launched during a previous association with the target AP.

The PRCM capabilities has been declared by the non-AP STA and the AP during the association procedure, in particular through the Extended Capabilities Information Element (IE) 1000. If a station indicates that it supports the PRCM capability, it is said PRCM-capable. The non-AP STA implementing the procedure of FIG. 3 is considered to be PRCM-capable.

Step 300 represents the association between the non-AP STA and the target AP using @MAC₀.

At step 310, the non-AP STA checks whether the target AP is PRCM-capable. This is made using the PRCM capability exchanged during the association procedure.

In the negative, no activation of the PRCM mechanism is required and next step is step 320 (end of the algorithm where conventional process is made).

In the affirmative, next step is step 330 where the non-AP STA checks whether the target AP is already PRCM-active with the non-AP STA.

If the target AP is PRCM-inactive with the non-AP STA, it means @MAC₀ is not a PRCM address but the default address. Nevertheless, the PRCM mechanism can be used. In that case, the PRCM mechanism is initiated at step 340.

The step may consist in setting the input parameters of the pseudorandom function (PRF) specified in the section 12.7.1.2 of the standard IEEE Std 802.11-2020 used to generate a MAC address. The PRF dedicated for the PRCM mechanism can be called PRCM PRF.

The PRCM PRF is based on four input parameters, denoted K, A, B and Len. The parameter Len is the number of pseudorandom bits (128, 192, 256, . . . ) generated by the PRF. In the context of the invention, the parameter Len may be initialized at 128 for which only the leftmost 46 bits (i.e. the 46 most significant bits) are selected. The function generating these 46 pseudorandom bits is referred to as PRF-128/46. The parameter K is a secret key coded on 256 bits, the parameter A is a text string specific to the application for which the PRF is used, and the parameter B is a variable length string.

The parameter K, referred to as PRCM key, shall be a secret information known by the non-AP STA and the target AP.

In one or more embodiments, the PRCM key may be a key obtained during the authentication and association procedures between the non-AP STA and the target AP. For example, after a successful authentication, the non-AP STA and the AP have a shared key called Pairwise Master Key (PMK), which is common to all the non-AP STAs of the BSS. After authentication, a 4-Way handshake is performed, during which a key specific to each non-AP STA is derived from the PMK, called Pairwise Transient Key (PTK), which is the key to be used for ciphering communications between the non-AP STA and the target AP. In one or several embodiments, the PMK may be used as PRCM key.

In alternative embodiments, the PRCM key may correspond to any key shared between the non-AP STA with the target AP. For example, this shared key may be stored in the memory of the device comprising the target AP (e.g. an internet connection box), and may also be read by a user on the housing of this device. The user may then enter this shared key manually, for example by means of a touch screen, into the user equipment comprising the non-AP STA. Of course, other solutions for the user equipment comprising the non-AP STA to recover the PRCM key are possible. For example, the PRCM key may be read elsewhere than on the housing of the device comprising the target AP (e.g. on a notice supplied with the device), or can be received directly on the user equipment comprising the non-AP STA from another equipment (e.g. by Short Message Service, SMS, or via a Bluetooth® connection). It is noted that in these embodiments, the PRCM key is common to all the non-AP STAs.

In the above embodiments, the PRCM key is not exchanged between the non-AP STA and the target AP. Therefore, the PRCM key cannot be recovered by a third party which would listen to the communications between the two entities (and could thus also calculate the next MAC address of the non-AP STA), which ensures the security of the MAC address change procedure.

In other embodiments, the PRCM key may be generated at the non-AP STA and transmitted to the target AP. Since the PRCM key is exchanged between the non-AP STA and the target AP, the communications between these entities must be secured. Of course, other embodiments are possible for obtaining and specifying the PRCM key, as long as both the non-AP STA and the target AP obtain the same key.

FIG. 6 illustrates an exemplary sequence of messages to exchange the PRCM key used by the shared PRCM mechanism. This procedure is initiated by the target AP which wants to retrieve the PRCM key generated by the non-AP STA. Here, after association, the PRCM key is shared between the two stations via specific action frames. The management frames for the association are not reproduced in this Figure.

The association procedure establishes a security context, so as the payload of any transmitted frame is encrypted.

In one or more embodiments, the AP 110 may transmit (step 610) a request to the non-AP station 120 to obtain a PRCM key. Alternatively, the request may be sent to a third device which transmits it to the non-AP station 120. For example, this request may be a “PRCM Key delivery Request” 710 as detailed below with reference to FIG. 7.

At the reception of the PRCM Key delivery Request, the non-AP station 120 may generate a PRCM key, for instance on 256 bits, to be used by the pair (AP, non-AP STA). The PRCM key may be constant, or it may vary, for instance for each SSID, AP or ESS, or fully random.

Once the PRCM key is generated, the non-AP station 120 may send it to the AP 110 in a message (step 620). This message may be for example a “PRCM Key delivery Response” 720 as detailed below with reference to FIG. 7.

At the reception of the message comprising the ERCM Key, the AP 110 may extract the key from the received message and store it. Also, in an optional step 630, the AP 110 may acknowledge the reception of the PRCM key to the non-AP station 120 by sending a confirmation message. For example, such message may be a “PRCM delivery Confirm” 730 as detailed below with reference to FIG. 7.

According to other embodiments of the invention, the PRCM mechanism may be initiated by a non-AP station 120. In such embodiments, the non-AP STA 120 may generate and spontaneously transmit the PRCM Key to the AP 110 (step 620) without having received any PRCM Key delivery Request from the AP. In such embodiments, step 610 is omitted.

FIG. 7 illustrates examples frame formats to initiate the PRCM mechanism by exchanging the PRCM Key, according to one or several embodiments of the invention. Those frames are action frames in the meaning of IEEE Std 802.11-2020.

All frame formats represented in FIG. 7 are identified by a ‘Category’ field assigned to a specific value k in the range [31,125] as specified in the table 9-51 of the IEEE Std 802.11-2020, so far reserved. For the purpose of illustration, a new category value is defined that is assigned for PRCM action frames. For example, new category value is set to 31. Of course, any other value in the above range may be used.

For example, the following may be added in the Table 9-51-Category values:

| Code | Meaning |
|---|---|
| 31 | Pseudo RCM |

The frame formats represented in FIG. 7 are identified by the single octet ‘PRCM Action’ field, which follows immediately the Category field. The values of the PRCM Action field may be defined as in the following table, that may be inserted at the end of 9.6 Action frame format details of the standard IEEE Std 802.11-2020:

| Action Field value | Meaning |
|---|---|
| 1 | PRCM Key delivery Request |
| 2 | PRCM Key delivery Response |
| 3 | PRCM Key delivery Confirm |

A PRCM Action field value set to 1 may correspond to a PRCM Key delivery Request 710. A PRCM Action field value set to 2 may correspond to a PRCM Key delivery Response 720. A PRCM Action field value set to 3 may correspond to a PRCM Key delivery Confirm 730.

For example, the PRCM Key delivery Request 710 may contain a Category field 711 set to value 31 and a PRCM Action field 712 set to value 1.

The PRCM Key delivery Response 720 may contain a Category field 721 set to value 31, a PRCM Action field 722 set to value 2 and a PRCM Key field 723 containing the PRCM Key as a 256-bit key.

The PRCM Key delivery Confirm 730 may contain a Category field 731 set to value 31 and a PRCM Action field 732 set to value 3.

Back to the parameters of the PRCM PRF, the parameter A is set to string “PRCM” to indicate that the PRF is used for calculating a new MAC address in the context of a PRCM mechanism.

The parameter B corresponds to any value known by both the non-AP STA and the target AP, and changing over time. It is not set at this stage, only when the PRCM mechanism is launched (step 360). In some embodiments as described below, this shared value is the current MAC address of the non-AP STA, i.e. @MAC₀. However, other embodiments may contemplate using another shared value, e.g. predefined values, a current time, and so on.

Next, at step 350, the status of the target AP (as considered by the non-AP STA) is changed from PRCM-inactive to PRCM-active. Next step is step 360.

If the target AP is determined to be PRCM-active with the non-AP STA at test 330, it means @MAC₀ is already a PRCM address, and the PRCM mechanism is currently used. The PRCM mechanism is thus launched at step 360.

Depending on the branches from step 330, the PRCM mechanism is launched to initiate (from step 350) the PRCM address for the non-AP STA or to update (from step 330) the current PRCM address.

The PRCM mechanism is launched with the function PRF-128/46 with the input parameters K and A as set in step 340 and the input parameter B set with the current MAC address of the non-AP STA @MAC₀.

The new/next PRCM address @MAC₁ (more generally @MACₙ) corresponds to the 46 output random bits for which it is added the U/L bit set to 1 and the I/G bit is set to 0. @MACₙ+1=PRF-128/46 (PRCM Key, “PRCM”, @MACₙ)

The PRCM address generated @MACₙ+1 will be effective only at the next association (so after a disassociation) with the same target AP. It is thus locally stored at step 370 in associating with the target BSSID. The non-AP STA will use the PRCM address at step 300 to initiate the association procedure another time with the same BSS.

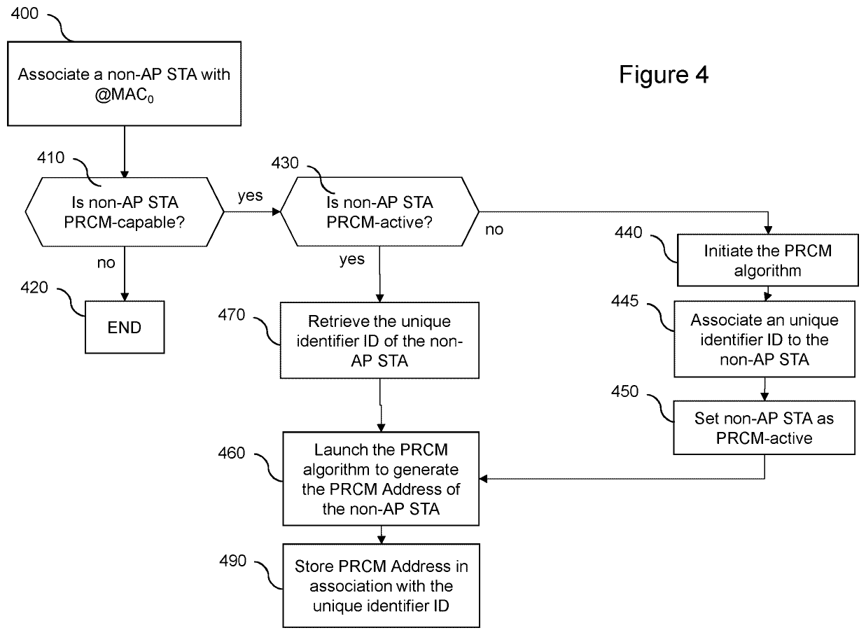

Corresponding steps at the target AP to manage, in particular to activate, the PRCM mechanism are now described with reference to FIG. 4.

Step 400 represents the association between the non-AP STA and the AP using @MAC₀.

At step 410, the AP checks whether the non-AP STA is PRCM-capable. This is made using the PRCM capability exchanged during the association procedure.

In the negative, no activation of the PRCM mechanism is required and next step is step 420 (end of the algorithm where conventional process is made).

In the affirmative, next step is step 430 where the AP checks whether the non-AP STA is already PRCM-active with the AP. This may be done by checking whether the current MAC address used by the non-AP STA, i.e. @MAC₀, is a PRCM address or not. This is checked by searching for this address in a history store (local registry) local to the AP where the latter stores all the PRCM address for the non-AP STAs (step 490 below).

If the non-AP STA is PRCM-inactive with the AP, it means @MAC₀ is not a PRCM address but the default address. Nevertheless the PRCM mechanism can be used. In that case, the PRCM mechanism is initiated at step 440 similar to step 340 described above (using the same parameters as those used by the non-AP STA considered).

Next to step 440, the AP associates, at step 445, an unique identifier ID to the non-AP STA. This identifier allows the AP to identify (track) and recognize the non-AP STA despite the changes of its MAC address. In particular, this identifier allows upper layers of the AP (typically service and application layers included in the AP) to be informed of the association of the non-AP STA. In other words, the MAC layer of the AP communicates with upper layers using the unique identifier ID for data concerning the non-AP STA.

Next, at step 450, the status of the non-AP STA (as considered by the AP) is changed from PRCM-inactive to PRCM-active. Next step is 460.

If the non-AP STA is determined to be PRCM-active with the AP at test 430, it means @MAC₀ is already a PRCM address, and the PRCM mechanism is currently used.

The AP retrieves, at step 470, the unique identifier ID of the non-AP STA. This is done by retrieving, from the local registry, the ID stored in association with the PRCM address @MAC₀ used, from amongst one or more pairs of (ID, PRCM address) corresponding to one or more non-AP STAs that have already registered to this AP.

This step means that when the AP receives, from a non-AP station, a management request (e.g. probe or association request during step 400) signaling a value of an EUI, it can search for the signaled EUI value within EUI values locally stored at the AP and obtain a unique local identifier associated with the locally-stored EUI value matching the signaled EUI value. Next step is step 460.

Similar to step 360, step 460 launches the PRCM mechanism to initiate (from step 450) or update (from step 470) the current PRCM Address of the non-AP STA.

The PRCM mechanism is launched with the function PRF-128/46 with the input parameters K and A as set in step 340/440 and the input parameter B set with the current MAC address of the non-AP STA @MAC₀.

The new/next PRCM address @MAC₁ (more generally @MACₙ) corresponds to the 46 output random bits for which it is added the U/L bit set to 1 and the I/G bit is set to 0. @MACₙ+1=PRF-128/46 (PRCM Key, “PRCM”, @MACₙ) As the PRCM mechanism has been initiated at step 440 with the same input parameters as step 340 (with reference to FIG. 3) and launched with the same input parameters as step 360 (still with reference to FIG. 3), step 460 generates the same PRCM address @MAC₁ (more generally @MACₙ+1 from @MACₙ) as step 360. Both stations have knowledge of the same PRCM address.

Next, at step 490, the AP stores, in the local registry, the correspondence between the new/updated PRCM address @MACₙ+1 and the unique identifier ID of the non-AP STA (generated the first time at step 450) to allow the non-AP STA to be recognize at the next association (step 470). This deletes the previous PRCM address @MACₙ stored in association with the non-AP STA. In other words, the AP station updates a current value of the EUI of the non-AP station locally associated with a unique local identifier, with the generated new value of the EUI.

In particular, this process means that when the non-AP STA is no longer associated with the AP, the AP considers only the PRCM address @MACₙ+1 to identify the non-AP STA, the address @MACₙ being deleted.

The above embodiments provide a PRCM address for the next association that can be generated at any time during a current association between the considered non-AP STA and target AP. In some embodiments, the PRCM address for the next association is generated during the disassociation procedure between the two stations. In a variant, this PRCM address may be generated upon association.

To increase user privacy, embodiments also provide that multiple RCM addresses are generated and used to identify the non-AP STA overtime during the operations 180 between this station and the AP.

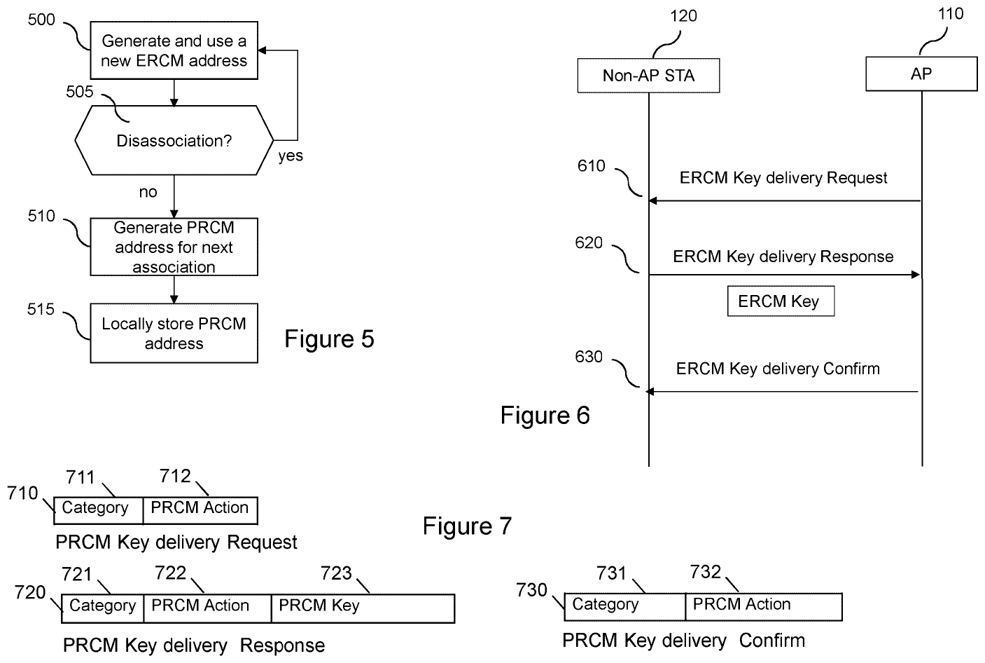

FIG. 5 illustrates, using a flowchart, exemplary steps at the non-AP STA or the AP during operations 180 within the BSS. These steps take place once the non-AP STA is associated with the AP until they disassociate.

In this scenario, a non-AP STA is optionally allowed to apply a RCM procedure when it is currently associated with the AP, to generate successive RCM addresses during operations 180, referred to as Enhanced RCM or “ERCM” addresses below. This allows the non-AP STA to dynamically change its MAC (ERCM) address over time while still being associated with the AP. This provides better user privacy.

The generated ERCM address relies also on the pseudorandom function (PRF) specified in the section 12.7.1.2 of the standard IEEE Std 802.11-2020 used to generate MAC addresses. The PRF dedicated for the ERCM mechanism may be noted “ERCM PRF” and is known by both the non-AP STA and the AP, in the same way as the PRCM PRF according to the invention. For example, the key exchange of FIGS. 6 and 7 may also be used to exchange an ERCM Key dedicated to the ERCM PRF.

At step 500, the non-AP STA or the AP generates one or more successive ERCM addresses using the ERCM PRF and assigns them to the non-AP STA for the subsequent communicates within the BSS (up to a next occurrence of step 500). Preferably, the next ERCM address is calculated based on the current ERCM address.

The ERCM address of the non-AP STA may be changed periodically or upon specific events (e.g. a triggering event in a beacon frame sent by the beacon frame).

Step 500 is repeated as long as the non-AP STA remains associated with the AP.

Test 505 checks whether a disassociation is pending. Disassociation may be triggered by a local event (the non-AP STA decides to leave the BSS or the AP decides to disassociate the non-AP STA) or a message (Disassociation frame) from the other station.

When a disassociation is detected, the non-AP STA or the AP generates at step 510 the PRCM address @MACₙ+1 for the next association, using the PRCM PRF.

Next, at step 515, the non-AP STA or AP stores, in the local registry, the PRCM address @MACₙ+1. In particular, the non-AP STA stores this information in association with the target AP (e.g. in association with the target BSSID—see step 370), while the AP stores it in association with the unique identifier ID dedicated to the non-AP STA (see step 490).

The ERCM and PRCM PRFs may have different parameters, i.e. two separate functions are used by each of the two stations to generate two types of MAC addresses. The ERCM mechanism and the PRCM mechanism are then executed separately.

The PRCM mechanism may generate the new PRCM Address using the current MAC address, i.e. a RCM address generated by the ERCM mechanism. This is possible for example when the PRCM Address is generated upon disassociation.

In a variant, the PRCM mechanism may generate the new PRCM Address using the original MAC address @MAC₀ when associating. In that case, the PRCM Address may be generated at any time during the current association.

When two different PRFs are used, the non-AP station, while being associated with the target AP, generates a plurality of successive new values of the EUI for the non-AP station by using another PRF than the PRCM PRF, and generated a new value of the EUI of the non-AP station to be used when performing the next association with the target AP.

In other embodiments, the ERCM and PRCM PRFs are identical, either one and the same PRF or two functions having the same parameters. In that case, the non-AP station, while being associated with the target AP, generates a plurality of successive new values of the EUI for the non-AP station by using the shared EUI-generating function, and the last (during the association) generated new value of the EUI is to be used when performing the next association with the target AP. The successive ERCM addresses are calculated based on the current MAC address of the non-AP STA when performing the calculation, and the PRCM address is calculated based on the last ERCM address, e.g. when disassociating.

It is recalled that the non-AP STA and the target AP perform the same operations to generate the various addresses.

In some configurations applicable to all or part of these embodiments, only one parameter K (the PRCM key above) is used by the ERCM and PRCM PRFs to generate both ERCM and PRCM addresses. In a variant, two separate parameters K are used: a first one, referred to as ERCM key, to be used by the ERCM PRF to generate the ERCM addresses and a second one, referred to as PRCM key, to be used by the PRCM PRF to generate the PRCM address.

In some configurations, only one parameter A, set to text string “ARCM” for instance (for Advanced RCM), is specified and used for generating both ERCM and PRCM addresses. In a variant, two separate parameters A are used: a first one, set to text string “ERCM” for instance, to be used by the ERCM PRF to generate the ERCM addresses and a second one, set to text string “PRCM” for instance, used by the PRCM PRF to generate the PRCM address.

When the algorithm combining ERCM and PRCM (possibly using the same PRF) is launched (by the non-AP STA and the AP) to generate the next ERCM address @MACᵢ₊₁^{ERCM}, it is done with the fixed parameters K and A and the input parameter B set with the current ERCM address @MACᵢ^{ERCM} of the non-AP STA.

When the non-AP disassociates with the AP, the same ARCM algorithm is launched with the last ERCM address @MACₙ^{ERCM} used by the non-AP STA (typically the current MAC address used by the non-AP STA for the disassociation procedure) to generate the PRCM address @MACₙ₊₁ to be used for the next association of the non-AP STA with the AP.

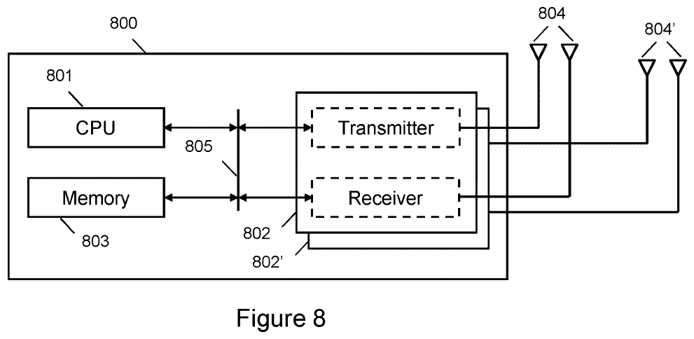

FIG. 8 schematically illustrates a communication device 800, typically any of the stations of FIG. 1, of a wireless network, configured to implement at least one embodiment of the present invention. The communication device 800 may preferably be a device such as a micro-computer, a workstation or a light portable device. The communication device 700 may comprise a communication bus 805 to which may be connected:
a central processing unit 801, such as a processor, denoted CPU;
a memory 803, denoted MEM, for storing an executable code of methods or steps of the methods according to embodiments of the invention as well as the registers adapted to record variables and parameters necessary for implementing the methods; and
at least two communication interfaces 802 and 802′ connected to the wireless communication network, for example a communication network according to one of the IEEE 802.11 family of standards, via transmitting and receiving antennas 804 and 804′, respectively.

Preferably the communication bus 805 may provide communication and interoperability between the various elements included in the communication device 800 or connected to it. The representation of the bus is not limiting and in particular the central processing unit is operable to communicate instructions to any element of the communication device 800 directly or by means of another element of the communication device 800.

The executable code may be stored in a memory that may either be read only, a hard disk or on a removable digital medium such as for example a disk. According to an optional variant, the executable code of the programs can be received by means of the communication network, via the interface 802 or 802′, in order to be stored in the memory 803 of the communication device 800 before being executed.

In an embodiment, the device 800 may be a programmable apparatus which uses software to implement embodiments of the invention. However, alternatively, embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A method for changing a value of an Extended Unique Identifier, EUI, of a non-access point, non-AP, station, the method comprising at the non-AP station:
while being associated with an AP station, generating a new value of the EUI of the non-AP station by using an EUI-generating function shared with the AP station; and
using the new value of the EUI when next associating with the AP station.

2. The method of claim 1, further comprising at the non-AP station: determining whether the non-AP station locally stores an EUI value in association with the AP station, and in the affirmative, using the stored EUI value to associate with the AP station, otherwise using a default EUI value to associate with the AP station.

3. The method of claim 2, wherein the default EUI value is a random MAC address obtained through Randomized and Changing procedure.

4. The method of claim 1, comprising at the non-AP station: performing a further next association with the AP station using a value of the EUI of the non-AP station different from a value of the EUI generated using the EUI-generating function shared with the AP station.

5. The method of claim 1, comprising at the non-AP station: disassociating from the AP station before using the new value of the EUI to next associate with the AP station.

6. The method of claim 1, comprising at the non-AP station: receiving a beacon frame from an AP station; searching, in a local registry, for an EUI value associated with a BSSID of the AP station; and sending a management request to the AP station using a found EUI value associated with the BSSID; otherwise using a default EUI value.

7. The method of claim 1, comprising at the non-AP station: while not being associated with an AP station, sending one or more management requests to one or more respective AP stations; receiving a management response from one of the respective AP stations; searching, in a local registry, for an EUI value associated with a BSSID of the responding AP station; and sending a further management request to associate with the responding AP station, wherein the further management request includes a found EUI value associated with the BSSID; otherwise includes a default EUI value.

8. A method for changing a value of an Extended Unique Identifier, EUI, of a non-access point, non-AP, station, the method comprising at an AP station:
generating a new value of the EUI of a non-AP station currently associated with the AP station, by using an EUI-generating function shared with the non-AP station;
using the new value of the EUI when next associating the non-AP station.

9. The method of claim 8, further comprising at the AP station: receiving, from a non-AP station, a management request signaling a value of an EUI of the non-AP station; searching for the signaled EUI value within EUI values locally stored at the AP station and obtaining a unique local identifier associated with the locally-stored EUI value matching the signaled EUI value.

10. The method of claim 9, further comprising at the AP station: updating a current value of the EUI of the non-AP station locally associated with the unique local identifier, with the generated new value of the EUI.

11. The method of claim 8, further comprising at the AP station: locally associating the generated new value of the EUI with a unique local identifier.

12. The method of claim 8, comprising at the AP station: disassociating the non-AP station before receiving, from the non-AP station, a request to associate again using the new value of the EUI.

13. The method of claim 5, wherein disassociating is made based on a current value of the EUI of the non-AP station different from the new value of the EUI.

14. The method of claim 1, wherein generating the new value of the EUI for the next association is performed during disassociation between the non-AP station and the AP station.

15. The method of claim 1, further comprising: while the non-AP station is associated with the AP station, generating a plurality of successive new values of the EUI for the non-AP station by using the shared EUI-generating function; wherein a last generated new value of the EUI is used when performing the next association.

16. The method of claim 15, wherein the last generated new value is generated when performing disassociation of the non-AP station from the AP station.

17. The method of claim 1, generating the new value of the EUI includes calculating the new value of the EUI by using a shared secret and a current value of a shared parameter as inputs of the shared EUI-generating function.

18. A wireless communication device comprising at least one microprocessor configured for carrying out the steps of the method of claim 1.

19. A non-transitory computer-readable medium storing a program which, when executed by a microprocessor or computer system in a wireless device, causes the wireless device to perform the method of claim 1.

20. A wireless communication device comprising at least one microprocessor configured for carrying out the steps of the method of claim 8.
